(19) United States
(12) Patent Application Publication
(10) Pub. No.: US 2009/0250566 A1
(43) Pub. Date: Oct. 8, 2009

(54) Toolbox stand

(76) Inventor: Chi-Wen Chen, Taipei City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/082,045

(22) Filed: Apr. 7, 2008

(51) Int. Cl. F16M 11/00

(52) U.S. Cl. 248/157

(57) ABSTRACT

A toolbox stand includes: an extendable supporting post including a lower part, an upper part telescopically connected to the lower part, and a coupler that couples the upper part to the lower part, the coupler defining a shoulder, the upper part having a top end and a bottom end formed with an abutting flange abutting against the shoulder when the upper part is moved relative to the lower part to a highest position; a plurality of extendable legs pivoted to the lower part; and a supporting frame pivoted to the top end of the upper part of the supporting post and adapted to support a toolbox thereon.

### BACKGROUND OF THE INVENTION

1. Field of the Invention

The invention relates to a toolbox stand, more particularly to a toolbox stand having an extendable supporting post.

2. Description of the Related Art

When assembling and disassembling or repairing an equipment, a toolbox carrying different kinds of tools is usually put on the floor nearby, which can result in inconvenience in fetching the tools in certain situations. For instance, the worker may need to bend his body or to stand up and squat down repeatedly to fetch the tools.

### SUMMARY OF THE INVENTION

Therefore, an object of the present invention is to provide a toolbox stand that can alleviate the aforesaid drawbacks.

Accordingly, a toolbox stand of this invention comprises: an extendable supporting post including a hollow lower part, an upper part that is telescopically connected and movable relative to the lower part, and a coupler that couples the upper part to the lower part, the lower part having a top end, the coupler being mounted on the top end of the lower part and having a lower portion that is sleeved on the lower part, and an upper portion that is sleeved on the upper part, that is reduced in cross-section from the lower portion, and that cooperates with the lower portion to define a shoulder therebetween, the upper part having a top end and a bottom end that is formed with an abutting flange extending outwardly and laterally therefrom, the abutting flange abutting against the shoulder when the upper part is moved relative to the lower part to a highest position; a plurality of extendable legs pivoted to the lower part; and a supporting frame pivoted to the top end of the upper part of the supporting post and adapted to support a toolbox thereon.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of the preferred embodiment of a toolbox stand adapted for holding a toolbox according to the present invention;

FIG. 2 is a partly sectional view of the preferred embodiment disposed at a retracted state;

FIG. 3 is an exploded perspective view showing an extendable leg and a bottom cover of the preferred embodiment;

FIG. 4 is a partly sectional view of the preferred embodiment disposed at an extended state;

FIG. 5 is a fragmentary top sectional view of one of the extendable legs disposed at an extended state;

FIG. 6 is a top view illustrating a supporting frame of the preferred embodiment disposed at an angular position;

FIG. 7 is a top view illustrating the supporting frame of the preferred embodiment disposed at another angular position; and

FIG. 8 is a perspective view illustrating the legs of the preferred embodiment disposed at a folded position.

### DETAILED DESCRIPTION OF THE PREFERRED EMBODIMENT

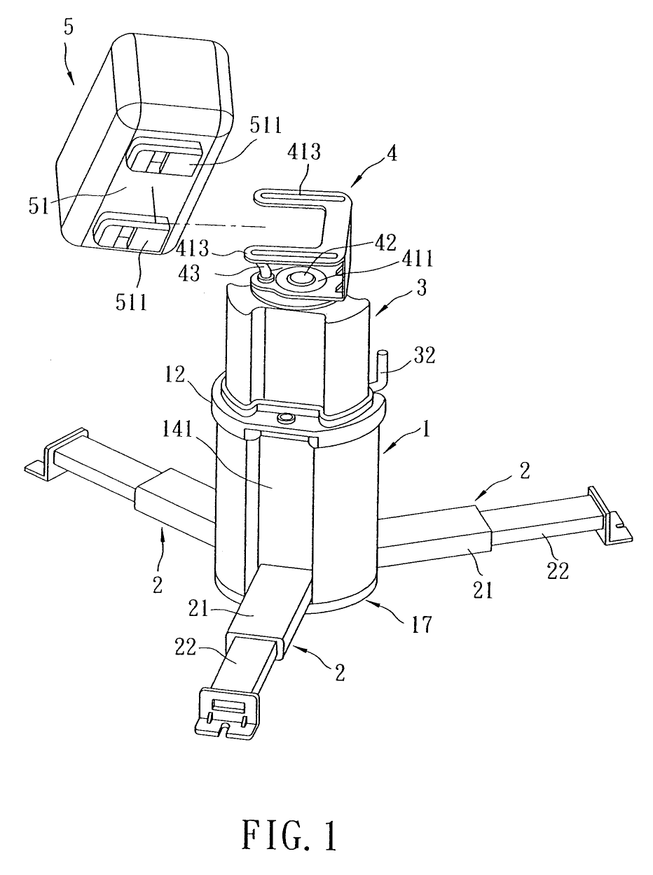

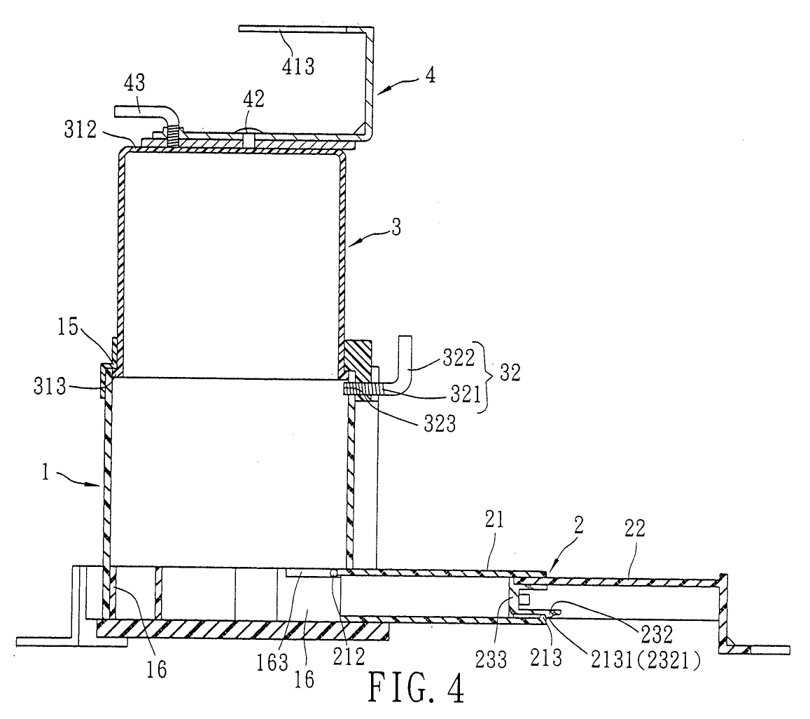

Referring to FIGS. 1 to 3, the preferred embodiment of a toolbox stand according to the present invention is shown to be adapted to hold a toolbox 5. The toolbox stand includes: an extendable supporting post including a hollow lower part 1, an upper part 3 that is telescopically connected and movable relative to the lower part 1, and a coupler 12 that couples the upper part 3 to the lower part 1, the lower part 1 having a top end, the coupler 12 being mounted on the top end of the lower part 1 and having a lower portion 123 that is sleeved on the lower part 1, and an upper portion 121 that is sleeved on the upper part 3, that is reduced in cross-section from the lower portion 123, and that cooperates with the lower portion 123 to define a shoulder 122 therebetween, the upper part 3 having a top end 312 and a bottom end that is formed with an abutting flange 313 extending outwardly and laterally therefrom, the abutting flange 313 abutting against the shoulder 122 when the upper part 3 is moved relative to the lower part 1 to a highest position (see FIG. 4), thereby preventing undesired removal of the upper part 3 from the lower part 1; three extendable legs 2 pivoted to the lower part 1; and a supporting frame 4 pivoted to the top end 312 of the upper part 3 of the supporting post through a pivot pin 42 and adapted to support the toolbox 5 thereon.

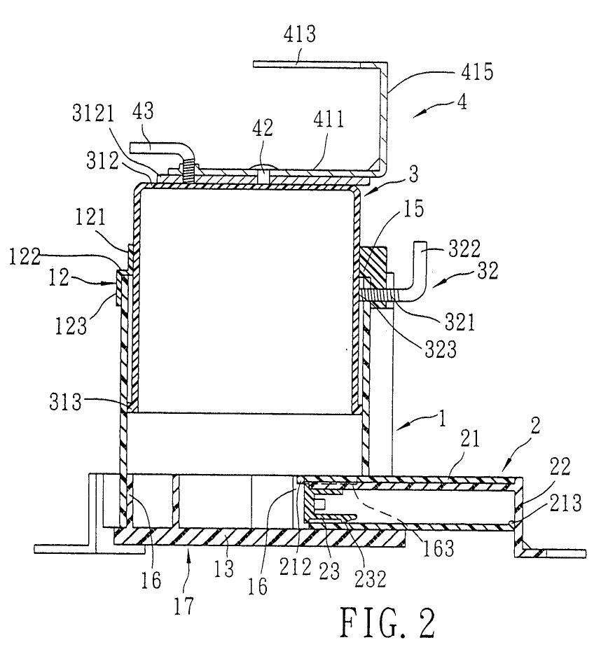

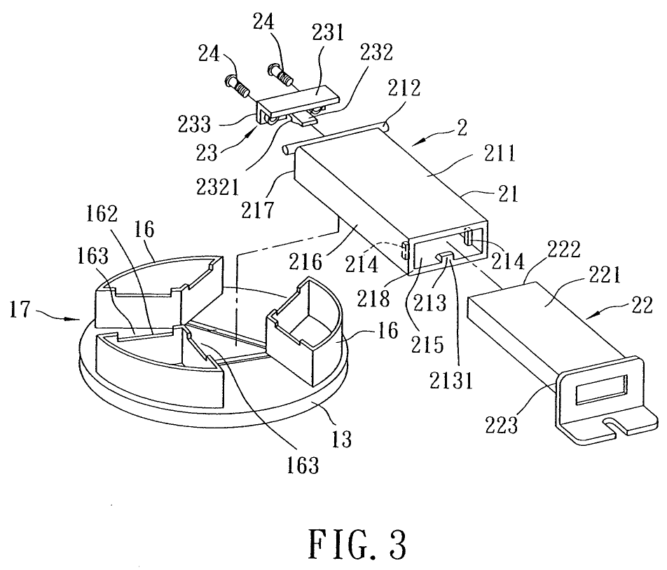

The toolbox stand further includes a bottom cover 17. The lower part 1 of the supporting post further has a bottom end. The bottom cover 17 extends fittingly into the bottom end of the lower part 1, and is provided with three sector-shaped protrusions 16 protruding into the lower part 1 and angularly displaced from each other. Each of the sector-shaped protrusions 16 is formed with two opposing retaining notches 163 (see FIG. 3), each of which is defined by a notch-defining wall 162. Each of the legs 2 has a connecting end provided with a pivot pin 212 with two opposite ends seated on and in sliding contact with the notch-defining walls 162 of an adjacent pair of the retaining notches 163 of two adjacent ones of the sector-shaped protrusions 16 (see FIG. 2).

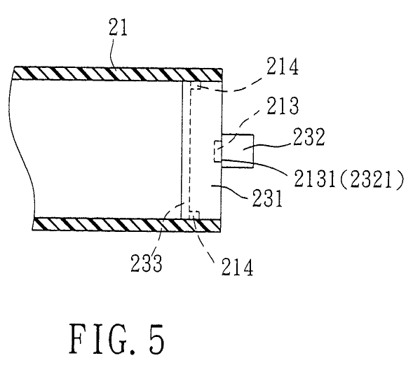

Each of the legs 2 has a hollow first arm 21 and a second arm 22 that is telescopically connected to and movable relative to the first arm 21. The hollow first arm 21 of each of the legs 2 has an inner end 217 that extends into the lower part 1 and that defines the connecting end of a respective one of the legs 2, and an outer end 218 that is disposed outwardly of the lower part 1 and that is formed with a first protrusion 213 protruding inwardly therefrom. The second arm 22 has an inner end 222 that extends into the first arm 21 and that is provided with an L-shaped plate 23 with a second protrusion 232 protruding therefrom, and an outer end 223 that is opposite to the inner end 222 of the second arm 22. The first protrusion 213 has an outer end face 2131 facing toward the outer end 223 of the second arm 22, and the second protrusion 232 has an inner end face 2321 facing toward the inner end 217 of the first arm 21. The inner end face 2321 of the second protrusion 232 abuts against the outer end face 2131 of the first protrusion 213 when the second arm 22 is moved relative to the first arm 21 to a longest position, as best shown in FIGS. 4 and 5.

The first arm 21 of each of the legs 2 has top and bottom walls 211, 215 and two opposite side walls 216 transverse to and interconnecting the top and bottom walls 211, 215 and respectively formed with stopping protrusions 214 protruding therefrom and disposed adjacent to the outer end 218 of the first arm 21. The first protrusion 213 protrudes from the bottom wall 215 toward the top wall 211. The L-shaped plate 23 has a first segment 231 parallel to the top and bottom walls 211, 215 of the first arm 21 and disposed adjacent to the top wall 211, and a second segment 233 transverse to the first segment 231 and in sliding contact with the bottom wall 215 of the first arm 21. The second protrusion 232 protrudes from the second segment 233 of the L-shaped plate 23. The second segment 233 of the L-shaped plate 23 of the second arm 22 of each of the legs 2 abuts against the stopping protrusions 214 of the side walls 216 of the first arm 21 of the leg 2 when the second arm 22 is disposed at the longest position, as best shown in FIG. 5. The L-shaped plate 23 is fastened to the inner end 222 of the second arm 22 through screw means 24.

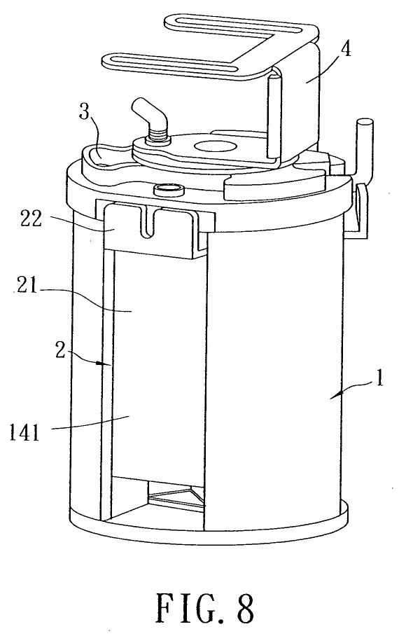

Referring again to FIGS. 1 and 2, in combination with FIG. 8, the lower part 1 is formed with three accommodating grooves 141 that are angularly displaced from each other and that extend along the length of the lower part 1. Each of the legs 2 has a shortest in length when the second arm 22 is disposed at a retracted position, i.e., the second arm 22 is fully retracted into the first arm 21 (see FIG. 2). Each of the legs 2 is received in a respective one of the accommodating grooves 141 in the lower part 1 when the leg 2 is disposed at the retracted position and is rotated about an axis of the pivot pin 212 relative to the lower part 1 to a folded position (see FIG. 8). Each of the legs 2 extends laterally and outwardly from the lower part 1 when the leg 2 is rotated about the axis of the pivot pin 212 relative to the lower part 1 to an extended position (see FIG. 1).

In this embodiment, the toolbox stand further includes a fastening member 32 extending threadedly through the coupler 12 and into the lower part 1 and having an abutting end 323 for abutting against the upper part 3 (see FIG. 2) so as to position the upper part 3 at a desired height relative to the lower part 1. The fastening member 32 is in the form of an L-shaped rod, and has a threaded shank section 321 and an operating section 322. The threaded shank section 231 engages threadedly the coupler 12.

In this embodiment, the supporting frame 4 has a mounting portion 411 pivoted to the top end 312 of the upper part 3, a riser portion 415 extending upwardly and transversely from the mounting portion 411, and a pair of inserting prongs 413 adapted for inserting into a pair of sleeves 511 connected to a bottom 51 of the toolbox 5, as shown in FIG. 1. A positioning member 43 extends threadedly through the mounting portion 411 and into a thread hole in a top plate 3121 for locking the supporting frame 4 to the top end 312 of the upper part 3.

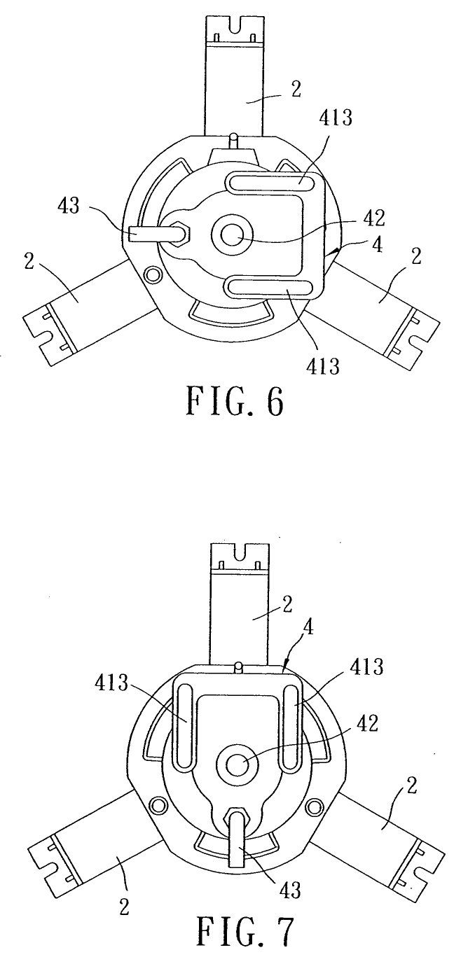

Referring again to FIG. 1, in combination with FIGS. 6 and 7, to adjust an angular position of the toolbox 5, the positioning member 43 is loosened so as to permit rotation of the supporting frame 4 to a desired angle, and the positioning element 43 is then tightened to arrest rotation of the supporting frame 4 after the supporting frame 4 is rotated to the desired angle.

With the use of the toolbox stand of this invention, fetching of tools from the toolbox 5 can be facilitated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A toolbox stand comprising:
an extendable supporting post including a hollow lower part, an upper part that is telescopically connected and movable relative to said lower part, and a coupler that couples said upper part to said lower part, said lower part having a top end, said coupler being mounted on said top end of said lower part and having a lower portion that is sleeved on said lower part, and an upper portion that is sleeved on said upper part, that is reduced in cross-section from said lower portion, and that cooperates with said lower portion to define a shoulder therebetween, said upper part having a top end and a bottom end that is formed with an abutting flange extending outwardly and laterally therefrom, said abutting flange abutting against said shoulder when said upper part is moved relative to said lower part to a highest position;
a plurality of extendable legs pivoted to said lower part; and
a supporting frame pivoted to said top end of said upper part of said supporting post and adapted to support a toolbox thereon.

2. The toolbox stand as claimed in claim 1, further comprising a bottom cover, said lower part of said supporting post further having a bottom end, said bottom cover extending fittingly into said bottom end of said lower part and being provided with a plurality of sector-shaped protrusions protruding into said lower part and angularly displaced from each other, each of said sector-shaped protrusions being formed with two opposing retaining notches, each of which is defined by a notch-defining wall, each of said legs having a connecting end provided with a pivot pin with two opposite ends respectively seated on and in sliding contact with said notch-defining walls of an adjacent pair of said retaining notches of two adjacent ones of said sector-shaped protrusions.

3. The toolbox stand as claimed in claim 1, wherein each of said legs has a hollow first arm and a second arm that is telescopically connected to and movable relative to said first arm.

4. The toolbox stand as claimed in claim 3, wherein said hollow first arm of each of said legs has an inner end that extends into said lower part and that defines said connecting end of a respective one of said legs, and an outer end that is disposed outwardly of said lower part and that is formed with a first protrusion protruding inwardly therefrom, said second arm having an inner end that extends into said first arm and that is provided with an L-shaped plate with a second protrusion protruding therefrom, and an outer end that is opposite to said inner end of said second arm, said first protrusion having an outer end face facing toward said outer end of said second arm, said second protrusion having an inner end face facing toward said inner end of said first arm, said inner end face of said second protrusion abutting against said outer end face of said first protrusion when said second arm is moved relative to said first arm to a longest position.

5. The toolbox stand as claimed in claim 4, wherein said first arm of each of said legs has top and bottom walls and two opposite side walls transverse to and interconnecting said top and bottom walls and respectively formed with stopping protrusions protruding there from and disposed adjacent to said outer end of said first arm, said first protrusion protruding from said bottom wall toward said top wall, said L-shaped plate having a first segment parallel to said top and bottom walls of said first arm and disposed adjacent to said top wall, and a second segment transverse to said first segment and in sliding contact with said bottom wall of said first arm, said second protrusion protruding from said second segment, said second segment of said L-shaped plate of said second arm of each of said legs abutting against said stopping protrusions of said side walls of said first arm of said leg when said second arm is disposed at the longest position.

6. The toolbox stand as claimed in claim 2, wherein said lower part is formed with a plurality of accommodating grooves that are angularly displaced from each other and that extend along the length of said lower part, each of said legs being received in a respective one of said accommodating grooves in said lower part when said leg is rotated about an axis of said pivot pin relative to said lower part to a folded position, and extending laterally and outwardly from said lower part when said leg is rotated about the axis of said pivot pin relative to said lower part to an extended position.

7. The toolbox stand as claimed in claim 1, further comprising a fastening member extending threadedly through said coupler and into said lower part and having an abutting end for abutting against said upper part so as to position said upper part at a desired height relative to said lower part.
